(19) United States
(12) Patent Application Publication
(10) Pub. No.: US 2025/0223108 A1
(43) Pub. Date: Jul. 10, 2025

(54) CORNET CONE PACKAGE TRANSMISSION LINE

(71) Applicant: Mondi Kale Nobel Ambalaj Sanayi Ve Ticaret Anonim Sirketi, Bakirkoy, Istanbul (TR)

(72) Inventors: Umit SAHIN, Luleburgaz, Kirklareli (TR); Mehmet Ulas IPEK, Bakirkoy, Istanbul (TR)

(21) Appl. No.: 18/850,877

(22) PCT Filed: Aug. 2, 2022
(86) PCT No.: PCT/TR2022/050807

§ 371 Date: Sep. 25, 2024

(30) Foreign Application Priority Data
Apr. 6, 2022 (TR) 2022/005454

(51) Int. Cl. B65G 15/12; B65G 15/44; B65G 21/08; B65G 21/20

(52) U.S. Cl. CPC B65G 15/12; B65G 15/44; B65G 21/08; B65G 21/2063; B65G 2201/0202

(57) ABSTRACT

Disclosed is a production machine which is used in producing the cornet cone packages used in the packaging of cornet-type ice-creams and which provides for the cornet cone packages to be horizontally fed and brought into a cone shape by being crimped.

### TECHNICAL FIELD

The invention is related to a transmission line used in the carrying of the cornet cone packages to the crimping machine used in the packaging of cornet-type ice-creams.

The invention is particularly related to a transmission line which provides for the proper and rapid transmission of the cornet cone packages to the crimping machines in the production line without error.

### PRIOR ART

Cornet-type ice-creams are among the top popular ice-creams frequently consumed. These ice-creams basically have conically shaped cornets filled with ice-creams having contents such as chocolate, toppings, fruits, nuts etc. Said cornets are sold by being placed in sleeve-like packages that cover the cornet part.

In the art, the standard cornet cone packages are cut into specific shapes before production and produced by being crimped into a conical shape in crimping machines. For this purpose, the cornet cone packages cut are stacked in order to be transferred to the crimping machines after the cutting process. The crimping machines shape the specifically shaped packages that are stacked into cones by crimping the same through rotation and form cone packages that are suitable for cornet cones. However, during the transmission of the specifically shaped packages to the crimping machine, problems such as deformation, tearing, and flying away are encountered and errors occur in production. Therefore, in the known state of the art, there is a need for an embodiment that provides the carrying of the specifically shaped cornet cone packages that are stacked after cutting to the crimping machine and eliminates the problems encountered during the crimping process.

In consequence, the presence of the above-mentioned problems and inefficiency of the present solutions requires a development in the related technical field.

### PURPOSE OF THE INVENTION

The present invention is related to a cornet cone package transmission line which eliminates the above-mentioned disadvantages and brings new advantages to the related technical field.

The main purpose of the invention is to present a transmission line which provides proper and rapid transfer of cornet cone packages to the crimping machines in the production line without error.

The purpose of the invention is to provide the transfer of the cornet cone packages that are stacked in order to be carried to the crimping machine rapidly and properly to the crimping machine, without encountering problems such as deformation, tearing or flying away.

In order to fulfill the above-mentioned purposes and the ones that can be inferred from the detailed description; the invention is a transmission line which is used in the carrying of the cornet cone packages that are used in the packaging of the cornet-type ice-creams to the crimping machine, comprising
a motion reel which makes a reciprocal rotational movement on at least both ends of the transmission line,
a driving motor which is connected with the motion reels, and which rotates the motion reels,
transmission belt which is located on the motion reels, and which carries the cornet cone packages thereon in order to transfer the same to the crimping machine by moving linearly with the rotational movement of the motion reels,
package pusher which is located on the transmission belt and which drives the cornet cone packages,
a top holder plate which is closed across the transmission line, and which prevents the cornet cone packages from flying away with the draft as they are carried.

The structural and characteristic features and all the advantages of the invention will be understood more clearly thanks to the figures given below and the detailed description written by making references to these figures. Therefore, the evaluation should be made in consideration of these figures and the detailed description.

### FIGURES AIDING THE DESCRIPTION OF THE INVENTION

FIG. 1: The representative view of the demounted state of the transmission line of the invention.

FIG. 2: Representational view of the transmission line of the invention.

### DESCRIPTION OF THE REFERENCE PARTS

10. Motion reel
20. Drive motor
30. Transmission belt
40. Package pusher
50. Transmission table
60. Roller
70. End holder
80. Side protection
90. Top holder plate
200. Cornet cone package

### DETAILED DESCRIPTION OF THE INVENTION

In this detailed description the preferred alternatives of the transmission line of the invention are described only for a better understanding of the subject and in the way to create no limiting effect whatsoever.

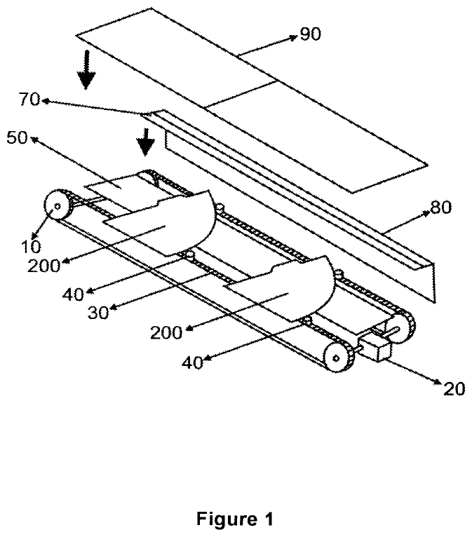

In FIG. 1, representational view of the transmission line of the invention has been given in the demounted state. Accordingly the transmission line basically comprises a motion reel (10) which makes a reciprocal rotational movement on at least both ends of the transmission line, a driving motor (20) which rotates the motion reels (10), a transmission belt (30) which moves linearly with the rotational movement of the motion reels (10) and carrying the cornet cone packages (200) thereon in order to transfer the same to the crimping machine, package pusher (40) which pushes the cornet cone packages (200) on the transmission belt (30), a transmission table (50) which prevents the cornet cone packages (200) between the transmission belts (30) from dropping down, a roller (60) which is located on the lower surface of the transmission belt (30) throughout the transmission line and which prevents the transmission belt (30) from dropping down, an end holder (70) which is located on both sides of the transmission line and which is positioned on the ends of the cornet cone packages (200), a side protection (80) which connects said end holder (70) to both sides of the transmission line, and which covers and protects both sides of the transmission line, a top holder plate (90) which is closed across the transmission line and which prevents the cornet cone packages (200) from flying away with the draft as they are carried.

In the transmission line of the invention in order for the cornet cone packages (200) to be carried to the crimping machine with linear movement motion reels (10) are placed reciprocally on at least both ends of the transmission line. The motion reels (10) make a rotational movement. The rotational movement of said motion reels (10) is provided by means of the drive motor (20) connected with the motion reels (10). On top of each one of the motion reels (10), a transmission belt (30) which moves linearly with the rotational movement of the motion reels (10), and which carries the cornet cone packages (200) thereon in order to transfer the same to the crimping machine is placed.

On top of the transmission belts (30) package pushers (40) which push the cornet cone packages (200) are placed. Between the transmission belts (30) there is a transmission table (50) which prevents the cornet cone packages (200) carried on the transmission belts (30) from dropping down. The cornet cone packages (200) are carried on a flat surface without dropping or falling down on the transmission table (50).

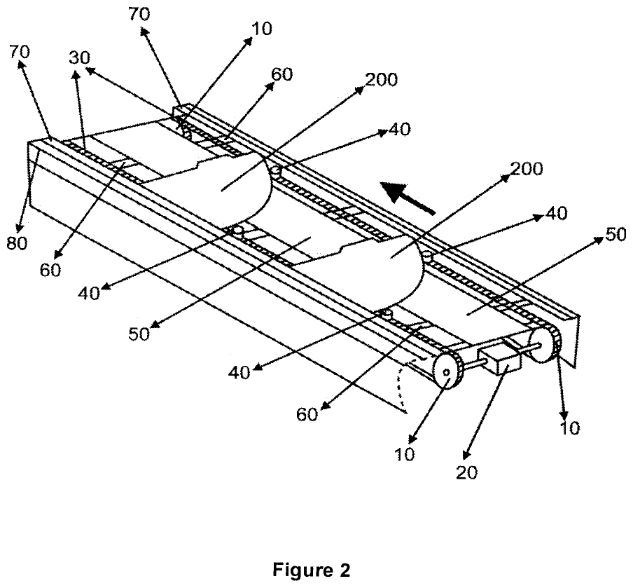

As can be seen in FIG. 2, there are rollers (60) present on the transmission belt (30) lower surface throughout the transmission line. Having a rotational movement, the rollers (60) prevent the transmission belt (30) from dropping down.

In order to prevent the end portions of the cornet cone packages (200) from being folded as they are carried end holders (70) are placed on both sides of the transmission line. Said end holder (70) is positioned on the ends of the cornet cone packages (200) and the cornet cone packages (200) are carried by remaining under the end holder (70).

The end holder (70) is connected on both sides of the transmission line by means of the side protection (80). At the same time, said side protection (80) covers both sides of the transmission line and protects the same from external factors.

A top holder plate (90) having a transparent structure is closed on the transmission line on which the cornet cone packages (200) are carried across the transmission line. Said top holder plate (90) prevents the cornet cone packages (200) from being flown away with the draft during the carrying.

The working principle of the transmission line according to the invention is as follows;

The transmission belts (30) move linearly and work the transmission line thanks to the rotational motion reels (10) with the movement of the drive motor (20). The cornet cone packages (200) are carried by linearly moving by being pushed by means of the package pushers (40) on the transmission belts (40). In the meantime, the cornet cone packages (200) are prevented from dropping down by means of the transmission table (50) between the transmission belts (40). At the same time, the ends of the cornet cone packages (200) move under the end holder (70) and prevent the deformation of the end portions. The cornet cone packages (200) carried from the transmission line are transferred to the crimping machine properly and rapidly in order to be brought to a cornet shape.

1. A transmission line used in the carrying of cornet cone packages to a crimping machine used in the packaging of cornet-type ice-creams, the transmission line comprising:
a motion reel which makes a reciprocal rotational movement on at least both ends of the transmission line;
a driving motor which is connected with the motion reels, and which rotates the motion reels;
a transmission belt which is located on the motion reels, and which carries the cornet cone packages thereon in order to transfer the same to the crimping machine by moving linearly with the rotational movement of the motion reels;
a package pusher which is located on the transmission belt, and which drives the cornet cone packages; and
a top holder plate which is closed across the transmission line, and which prevents the cornet cone packages from flying away with the draft as they are carried.

2. A transmission line according to claim 1, comprising a transmission table which is located between the transmission belts, and which prevents the cornet cone packages from dropping down.

3. A transmission line according to claim 1, comprising a roller which is located on the lower surface of said transmission belt across the transmission line, and which prevents the transmission belt from dropping down.

4. A transmission line according to claim 1, comprising an end holder which is located across both sides of the transmission line, and which is positioned on the ends of the comet cone packages in order to prevent the end portions from folding as the cornet cone packages are carried.

5. A transmission line according to claim 1, comprising a side protection which connects said end holder to both sides of the transmission line, and which covers and protects both sides of the transmission line.
